(19) United States
(12) Patent Application Publication
(10) Pub. No.: US 2006/0179407 A1
(43) Pub. Date: Aug. 10, 2006

(54) Trusted display device for visual cryptography

(76) Inventors: Pim Theo Tuyls, EINDHOVEN (NL); Mark Thomas Johnson, Eindhoven (NL); Thomas Andreas Maria Kevenaar, Eindhoven (NL); Geert Jan Schrijen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,369

(22) PCT Filed: Mar. 15, 2004
(86) PCT No.: PCT/IB04/50258

§ 371 Date: Sep. 14, 2005

(30) Foreign Application Priority Data
Mar. 17, 2003 (EP) 03100670.3

(51) Int. Cl. G06F 3/00

(52) U.S. Cl. 715/700

(57) ABSTRACT

A trusted display device (1) for, upon being superimposed on an untrusted display (2), reconstructing a graphical message, said device comprising a display screen (1a) having a plurality of independently addressable pixels. A plurality of sensors (1c) are associated with at least a subset of the pixels of said display screen (1a) and arranged such that they, when the displays (1, 2) are superimposed, are able to detect optically encoded information presented by an underlying pixel of the untrusted display (2) and adapt the activation of its pixels based on said information sensed.

The present patent application relates to the field of display devices for visual cryptography, and particularly to a trusted display device usable on any kind of untrusted display devices and a method for reconstructing a graphical message thereupon.

Visual cryptography (M. Naor, A. Shamir: Visual Cryptology, Eurocrypt '94, Springer-Verlag LNCS Vol. 950, Springer-Verlag, 1995, pp 1-12) can briefly be described as follows. An image is split into two randomized parts, the image plus a randomization and the randomization itself. Either part contains no information on the original image because of the randomization. However, when both parts are physically overlaid the original image is reconstructed.

If the two parts do not fit together, no information on the original image is revealed and a random image is produced. Therefore if two parties want to communicate using visual cryptography, they have to share the randomization. A basic implementation would be to give a receiving party a transparency containing the randomization. The sender would then use this randomization to randomize the original message, and transmit the randomized message to the receiver, on a transparency or any other means. The receiver puts the two transparencies on top of each other and recovers the message. This scheme can be compared to a one time pad.

A more flexible implementation is obtained when using two display screens, e.g. two Liquid Crystal Display (LCD) screens. A first screen displays the image plus randomization and a second screen displays the randomization itself. If the screens are put on top of each other, i.e. superimposed, the reconstructed image appears. Such a device capable of reconstructing graphical messages produced using visual cryptography can e.g. make use of the polarization rotating effect of liquid crystal cells in a liquid crystal display. Such a device is described in European patent application 02075527.8 (attorney docket PHNL020121) and in European patent application 02078660.4 (attorney docket PHNL020804).

Polarization filters in liquid crystal displays only transmit light with a particular polarization. Normally a liquid crystal cell rotates the polarization of the light that passes through it over a certain angle. If a sufficient voltage is applied to the cell, no rotation takes place. This is referred to as “activating” that cell. Light will not be visible if the total rotation of the polarization of the incoming light, after passing the two superimposed liquid crystal layers, is perpendicular to the polarization direction of a second polarization filter.

After receiving a sequence of information units, preferably a sequence of binary values, the device renders the sequence on the first liquid crystal display by activating or not activating cells in the liquid crystal layer. No processing or decryption step is necessary before any displaying takes place, i.e. the information units are displayed as they are received. On the second display another pattern is displayed, which is generated based entirely on a key sequence.

Reconstruction of the image is performed by superimposing the first and second displays in the correct alignment, so that the user can see the reconstructed graphical message. The reconstruction is performed directly by the human eye and not by a device which might be compromised. This makes use of visual cryptography to communicate secret information more securely.

It is possible to encode pixels of the graphical message as binary values or to use the intensity of the pixels of the message in the encoding, depending on whether a black and white or a colored graphical message is to be encoded and reconstructed.

However, an important problem with prior art attempts to use the above described implementation is that the two liquid crystal layers from the two displays must be superimposed without intervening polarization filters. Otherwise these filters will block some of the light, which will cause the reconstruction to fail.

One prior art approach to solving this problem has been to provide as an untrusted display, an LCD display where the polarization filter can be removed or displaced. This makes it cumbersome to implement visual cryptography to systems using as a first untrusted display a public computer terminal, ATM machine or other general purpose device of ordinary design having e.g. an LCD display with a polarization filter above the liquid crystal layer, a CRT display or a polyled display.

Accordingly, it is an object of the present invention to provide an improved trusted display device usable on any kind of untrusted display device.

Another object of the invention is to provide an improved trusted display device based on the polarization rotating effect of liquid crystal cells in a liquid crystal display.

A further object of the invention is to provide an improved method for reconstructing a graphical message on a display screen of a trusted display device.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In the drawings, wherein like reference characters denote similar elements throughout the several views:

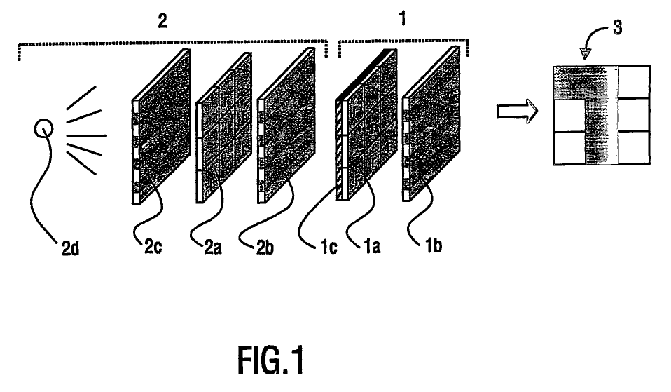

FIG. 1 discloses a schematic illustration of a trusted liquid crystal display device, according to a first embodiment, here shown used in combination with an untrusted liquid crystal display of ordinary design, i.e. with a polarization filter above the liquid crystal layer;

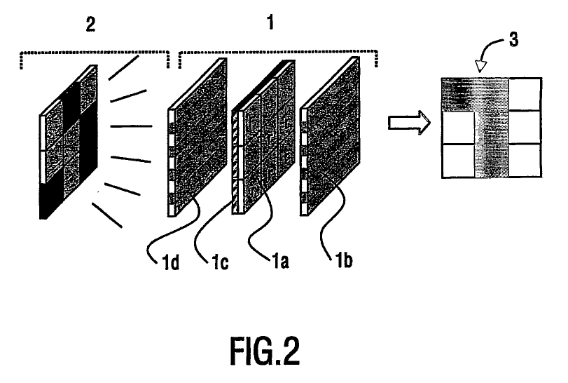

FIG. 2 discloses a schematic illustration of a trusted liquid crystal display device, according to a second embodiment, here shown used in combination with an untrusted device that makes use of an emissive display.

FIG. 1 shows a schematic illustration of a trusted display device 1, based on a liquid crystal display screen 1a, according to a first embodiment. The trusted display 1 is here shown used in combination with an untrusted liquid crystal display 2 of ordinary design, i.e. with a polarization filter 2b above (in FIG. 1 illustrated to the right of) the liquid crystal layer 2a and an additional polarization filter 2c below (in FIG. 1 illustrated to the left of) the liquid crystal layer 2a, which untrusted display is illuminated by a light source 2d. For simplicity both displays 1, 2 are shown as 3×3 pixel displays, but it is evident to the person skilled in the art that they could comprise any number of pixels.

The trusted display device 1 comprises a first polarization filter 1b, a liquid crystal layer la a second side of which is essentially covered by the first polarization filter 1b. Each pixel of the liquid crystal layer 1a of the trusted display device 1 is independently addressable and a layer of sensors 1c are arranged at a first side of said liquid crystal layer 1a embedded in said pixels, such that there is preferably at least one respective sensor for each pixel of the display 1. Each sensor is arranged such that it, when the displays 1, 2 are superimposed as in FIG. 1, will sense information presented by an underlying pixel of the untrusted display 2. In alternative embodiments, only a portion of the display 1 may be provided with sensors, or only a subset of the pixels may be provided with sensors, or both.

In the following it is assumed, for the sake of explanation, that the polarization filter 2b of the untrusted display 2 is horizontally polarized. In reality the polarization direction of the polarization filter 2b on the untrusted display may have any direction, which can be measured by the trusted display device 1, e.g. by equipping the untrusted display 2 with two areas covered with a horizontal and a vertical polarization filter and measuring the intensities of the light emitted in those areas, the polarization direction of the polarization filter on the untrusted display 2 can be derived.

A trusted computer (not shown) will present its information on the untrusted display 2 according to the following procedure, the scheme of which is explained for black and white pictures but can easily be extended to grayscales and color schemes. The trusted computer constructs a random share consisting of black and white pixels only. If the image is represented as a bit string I ∈Z₂ⁿ of length n and the key as K, which is computed using a pseudo random number generator, which is synchronized with the one of the user, then this random share R ∈Z₂ⁿ is given by:
R=I⊕K

Further, 0 is interpreted as white and 1 as black. The liquid crystal layer 2a of the untrusted display 2 is driven as follows. If the i-th bit of R equals zero, then a voltage has to be applied to the i-th cell of the liquid crystal layer 2a of the untrusted display 2. Therefore white light will come out of the i-th cell of the untrusted display 2. If the i-th bit of R equals 1, then the i-th pixel of the untrusted display 2 will not be made black but it will also be made white. However, the i-th pixel will be made flickering for a very short time. Such flickering is an example of optically encoded information. After a short period of time, during which some of the pixels are flickering, the untrusted display 2 will be made completely white and will be used as a backlight. In the example illustrated in FIG. 1, the pixels of the untrusted display 2 made flickering are indicated with the letter “r”.

The key generator of the trusted display 1 consists of two algorithms. A first part consists of the algorithm that would be used if the untrusted display 2 has no top polarization filter 2b, referred to as algorithm 1. The second part of the algorithm will be explained later and will be referred to as algorithm 2.

The sensor of the i-th pixel of the trusted display 1 measures whether the pixel of the untrusted display 2 is flickering or not. If it is not flickering, then it interprets the incoming light of the untrusted display 2 as if it was meant to be horizontally polarized, which is the direction of the polarization filter 2b on top of the untrusted display 2, as we assumed. Algorithm 1 then computes the angle of rotation of the polarization of the light according to the value of the i-th key bit of K and applies the appropriate voltage to the i-th cell of the liquid crystal layer 1a.

As illustrated by the visual output scheme 3 to the far right in FIG. 1, if the pixel of the untrusted display 2 is not flickering and the corresponding pixel of the trusted display I is not marked with an “r”, the pixel of the trusted display 1 will be made white, i.e. pass on the horizontally polarized light. If the pixel of the untrusted display 2 is not flickering and the corresponding pixel of the trusted display 1 is marked with an “r”, the pixel of the trusted display 1 will be made black, i.e. the light passing there through will be rendered a polarization direction which is orthogonal to incident light and is therefore stopped by the first polarization filter 1b.

In the case the i-th pixel is flickering, the sensor of the i-th pixel in the trusted display 1 registers this and sends this information to the key generation algorithms 1 and 2. The key generation algorithm 1 interprets this information as the fact that the polarization direction is meant to be vertically polarized, i.e. orthogonal to the real polarization direction, which in practice is horizontal due to the horizontal polarization filter 2b on the untrusted display 2. Then, it computes according to the i-th bit of K what the color c of the outgoing light would be if the light coming out of the untrusted display 2 is vertically polarized. Now, algorithm 2 computes which rotation it has to apply to horizontally polarized light coming out of the untrusted display 2, to get the required color c. The appropriate voltage that has to be applied to the i-th liquid crystal cell is then computed.

As further illustrated by the visual output scheme to the far right in FIG. 1, if the pixel of the untrusted display 2 is flickering and the corresponding pixel of the trusted display 1 is not marked with an “r”, the pixel of the trusted display 1 will be made black, i.e. the light passing there through will be rendered a polarization direction which is orthogonal to that of the incident light and is therefore stopped by the first polarization filter 1b. If the pixel of the untrusted display 2 is flickering and the corresponding pixel of the trusted display 1 is marked with an “r”, the pixel of the trusted display 1 will be made white, i.e. pass on the horizontally polarized light.

It should be unambiguous to the person skilled in the art that the way explained above of transferring additional optically encoded information on the polarization direction when using liquid crystal displays is not limited to flickering. Other techniques such as intensity variations can be used to transfer this information.

FIG. 2 illustrates that if a second polarization filter Id (possibly a switchable polarization filter) is added on the bottom of the trusted display 1 of FIG. 1, below (in FIG. 2 illustrated to the left of) the sensor layer 1c, the same technique can be applied to a trusted display device 1 to be used with untrusted devices that makes use of emissive displays 2, such as CRT displays, polyled displays or similar.

It should further be obvious to the person skilled in the art, that the same technique for transferring pixel states from an untrusted display 2 to a trusted display 1 for reconstructing a visual cryptography graphical message can be applied to a trusted display device 1 based on any type of display screen.

A method for reconstructing a graphical message on a display screen of a trusted display device said display screen having a plurality of independently addressable pixels and sensors, comprise the steps of:

superimposing said display screen of said trusted display device on an untrusted display;

sensing information presented by an underlying pixel of the untrusted display using said sensors;

adapting the activation of the pixels of said display screen of said trusted display device based on said information sensed.

In a further embodiment the method further comprise the step of operating the untrusted display device as a backlight for the trusted display device once the step of adapting the activation of the pixels of said display screen of said trusted display device has been performed.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A trusted display device (1) for, upon being superimposed on an untrusted display (2), reconstructing a graphical message, said device comprising a display screen (1a) having a plurality of independently addressable pixels, and a plurality of sensors (1c) associated with at least a subset of the pixels of said display screen (1a) and arranged such that they, when the displays (1, 2) are superimposed, are able to detect optically encoded information presented by an underlying pixel of the untrusted display (2).

2. The display device of claim 1, wherein said subset of pixels of said display screen (1a) comprises all pixels of said display screen (1a).

3. The display device of claim 1, wherein said display device (1) further comprise at least one sensor associated with each pixel of said display screen (1a).

4. The display device of claim 1, wherein the optically encoded information is in the form of time or amplitude modulated light intensity.

5. The display device of claim 1, wherein said display device (1) further comprises means for adapting the activation of its pixels based on said information sensed.

6. The display device of claim 1, wherein said display screen (1a) is a liquid crystal display screen a first side of which comprise said sensors (1c) and a second side of which is essentially covered by a first polarization filter (1b) and said display device (1) further is arranged to receive upon said sensors (1c) incident light of a first polarization direction.

7. The display device of claim 6, wherein said display device (1) further comprises a key generator, arranged to activate the pixels in accordance with either of a first and a second algorithm based on said information sensed.

8. The display device of claim 7, wherein said first algorithm is used to interpret pixels displaying optically encoded information, and said second algorithm for interpreting other pixels.

9. The display device of claim 7, wherein said second algorithm is arranged to be used to compute the pixel state when said information indicates that the incident light should be considered to have a polarization direction which is different to said first polarization direction and said first algorithm is used to compute the pixel state otherwise.

10. The display device of claim 6, wherein said display device (1) further comprise a second polarization filter (1d), essentially covering said first side of said liquid crystal display screen (1a) and arranged to provide upon said sensors (1c) incident light of said first polarization direction.

11. A method for reconstructing a graphical message on a display screen of a trusted display device said display screen having a plurality of independently addressable pixels and sensors, said method comprising the steps of:
superimposing said display screen of said trusted display device on an untrusted display;
sensing information presented by an underlying pixel of the untrusted display using said sensors;
adapting the activation of the pixels of said display screen of said trusted display device based on said information sensed.

12. A method according to claim 11, said method further comprising the step of:
operating the untrusted display device as a backlight for the trusted display device once said step of adapting the activation of the pixels of said display screen of said trusted display device has been performed.
